(19) United States
(12) Patent Application Publication
(10) Pub. No.: US 2009/0085529 A1
(43) Pub. Date: Apr. 2, 2009

(54) POWER SOURCE

(76) Inventors: Tom Allen Agan, Saint Paul, MN (US); James Chyi Lai, Saint Paul, MN (US); Chien-Chiang Chan, Chung-Ho City (TW)

Correspondence Address: PATTERSON & SHERIDAN, L.L.P., 3040 POST OAK BOULEVARD, SUITE 1500, HOUSTON, TX, 77056, US

(21) Appl. No.: 11/865,484

(22) Filed: Oct. 1, 2007

(51) Int. Cl. H02J 1/00

(52) U.S. Cl. 320/166

(57) ABSTRACT

An electronics system module is provided. The electronics system module includes an electronics device and a power source. The power source includes a capacitor coupling to the electronics device and providing power thereto and an adjustable resistance connected in series between the capacitor and the electronics device. The resistance is adjusted by a control mechanism, so that the voltage supplied to the electronics device from the capacitor is constant.

### BACKGROUND OF THE INVENTION

1. Field of the Invention

The present invention relates to a power source. More particularly, the present invention relates to a power source with an adjustable resistance.

2. Description of Related Art

A typical type of power source for providing power to a system such as any electronics device is a battery. A battery provides a constant voltage (or current) to the electronics device so that the electronics device may be powered by a stable power source. The electronics device may be any device needing electrical power for operation, such as an electric motor, household appliances, a mobile communication device, or a computer. A battery typically maintains its voltage for a significant period of time and the voltage only decreases when the battery is mostly discharged.

The use of batteries as power sources for electronics devices suffer from a couple of problems. First, a re-chargeable battery has a limited number of re-charges and as the battery is re-charged towards that limit, the capacity of the battery will start to decrease. Second, a battery has a memory problem, in that if the battery is only partially charged, or if the battery is charged before the complete depletion of energy, then the capacity of the battery may decrease according to the amount charged in the previous charge cycle. Also, batteries may take a long time to charge and the cost of material for a battery is high.

For the forgoing reasons, there is a need for a new type of power source, which can be an alternative to a battery while overcoming the problems possessed by a battery.

### SUMMARY OF THE INVENTION

The present invention is directed to a power source, that it satisfies this need of a power source capable of a higher number of re-charges and can be partially charged and discharged without degradation in capacity. The power source includes a capacitor and an adjustable resistance. The capacitor couples to the electronics device and providing power thereto and an adjustable resistance connected in series between the capacitor and the electronics device. The resistance is adjusted by a control mechanism, so that the voltage supplied to the electronics device from the capacitor is constant.

The capacitor included in the power source may have a significantly higher number of re-charge cycles compared to batteries. Also, the capacitor may be partially charged or discharged without a reduction in charge capacity. Furthermore, the adjustable resistance provides fast charging of the capacitor when the capacitor is charged at a charge point connected between the capacitor and the adjustable resistance.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a system diagram of an electronics system module according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

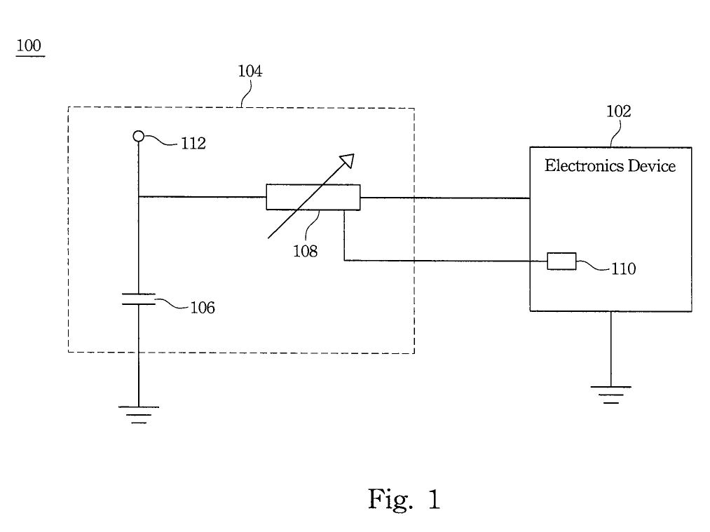

Please refer to FIG. 1, a system diagram of an electronics system module according to an embodiment of the present invention. The electronics system module 100 includes an electronics device 102, and a power source 104. The electronics device 102 may be any device operated by electricity, such as an electric motor, a mobile communications device, or a computer. The power source 104 includes a capacitor 106 and an adjustable resistance 108. The capacitor 106 couples to the electronics device 102. For example, one electrode of the capacitor 106 may be electrically coupled to a power supply input pin of the electronics device 102. The other electrode of the capacitor 106 may be electrically connected to ground, thus forming a closed loop system. The electric charged stored in the capacitor 106 (typically a large value capacitor) may provide power to the electronics device 102. The adjustable resistance 108 is connected in series between the capacitor 106 and the electronics device 102. The adjustable resistance 108 may be a rheostat, a potentiometer, or a voltage controlled variable resistor. The resistance 108 may be adjusted by a control mechanism 110, so that the voltage supplied to the electronics device 102 from the capacitor 106 is constant.

By adjusting the resistance 108, the voltage seem at the load (the power supply pin of the electronics device) may be adjusted accordingly. The control mechanism 110 may be a voltage controlled mechanism integrated into the electronics device 102 so that no additional voltage controller is needed outside of the system module 100 to adjust the resistance 108. The control mechanism 110 may sense the voltage at the load and compare it with the desired voltage at the load. If the voltage at the load provide by the capacitor 102 is too low or too high, the control mechanism 110 may apply a voltage to the adjustable resistance 108 to change the resistance value. For example, if the desired voltage is 5 volts and the voltage at the load connected to the current resistance value is 4.3 volts, the control mechanism 110 may apply a voltage to the adjustable resistance 108 and lower the resistance of the adjustable resistance 108 so that more current may flow through the load and causing a voltage increase at the load to match the desired voltage of 5 volts. The control mechanism 110 may also be a manual controlled mechanism, such as by human hands or any control mechanism without automatic voltage adjustments. Unlike batteries, when capacitors are being discharged, the voltage across the capacitor will start to drop. Therefore, the control mechanism 110 may need to monitor the voltage at the load and adjust the resistance 108 constantly.

In addition, the adjustable resistance 108 is advantageous for providing a power source, which may be charged in a short period of time. If the capacitor 106 is charged at a charging point 112 connected between the capacitor 106 and the adjustable resistance 108, then by lowering the resistance of the adjustable resistance 108, the RC effect at the charge point 112 may be reduced. In other words, less resistance seemed at the charge point translate to a smaller RC time constant for the capacitor to charge. Therefore, the charging time of the capacitor 106 may be controlled by the tuning of the adjustable resistance 108, which is controlled by the control mechanism 110.

In conclusion, the embodiment of the present invention is a power source, which may be a part of an electronics system module. The power source provides electrical power to the electronics device within the system module. The power source may be a capacitor coupling to the electronics device. An adjustable resistance is connected in series between the power source and the system. The adjustable resistance is controlled by a control mechanism, which controls the resistance value of the adjustable resistance so that the voltage (or current) delivered to the electronics device is constant. Also, the adjustable resistance may be controlled so to reduce the charging time of the capacitor while the capacitor is being charged at a charging point connected between the capacitor and the adjustable resistance.

The above mentioned power source may be re-charged significantly more times than regular batteries. The power source also can be charged or discharged without the concern of losing capacitor. Lastly, the embodiment of the present invention provides a power source, which has a significantly faster re-charging time compared to batteries.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power source for supplying power to a system, comprising:
a capacitor coupling to the system and providing power thereto; and
an adjustable resistance connected in series between the capacitor and the system, wherein the resistance is adjusted by a control mechanism, so that the voltage supplied to the system from the capacitor is constant.

2. The power source of claim 1, wherein the system is an electronics device.

3. The power source of claim 1, wherein the adjustable resistance is a rheostat, a potentiometer, or a voltage controlled variable resistor.

4. The power source of claim 1, wherein the control mechanism is a voltage controlled mechanism.

5. The power source of claim 1, wherein the control mechanism is a manual controlled mechanism.

6. The power source of claim 1, wherein the control mechanism is integrated into the system.

7. The power source of claim 1, wherein the control mechanism decreases the adjustable resistance according to the discharge of the capacitor.

8. An electronics system module, comprising:
an electronics device; and
a power source, comprising:
a capacitor coupling to the electronics device and providing power thereto; and
an adjustable resistance connected in series between the capacitor and the electronics device, wherein the resistance is adjusted by a control mechanism, so that the voltage supplied to the electronics device from the capacitor is constant.

9. The electronics system module of claim 8, wherein the system is a motor, a computer, a mobile communications device, or a household appliance.

10. The electronics system module of claim 8, wherein the adjustable resistance is a rheostat, a potentiometer, or a voltage controlled variable resistor.

11. The electronics system module of claim 8, wherein the control mechanism is a voltage controlled mechanism

12. The electronics system module of claim 8, wherein the control mechanism is a manual controlled mechanism.

13. The electronics system module of claim 8, wherein the control mechanism is integrated into the system.

14. The electronics system module of claim 8, wherein the control mechanism decreases the adjustable resistance according to the discharge of the capacitor.

15. The electronics system module of claim 8, further comprising a charge point connected between the capacitor and the adjustable resistance, wherein the capacitor is charged at the charge point.

16. The electronics system module of claim 15, wherein the adjustable resistance is adjusted by the control mechanism, so that the time needed to charge the capacitor is shortened.
